(19) United States
(12) Patent Application Publication
(10) Pub. No.: US 2024/0354604 A1
(43) Pub. Date: Oct. 24, 2024

(54) NON-LINEAR MULTI-DIMENSIONAL COST FUNCTION FOR ARTIFICIAL INTELLIGENCE INFERENCE

(71) Applicant: SAMSUNG ELECTRONICS CO., LTD., SUWON-SI, GYEONGGI-DO (KR)

(72) Inventors: Ayelet Hen, Tel-Aviv (IL); Omer Shabtai, Tel-Aviv (IL); Eilon Regev, Tel-Aviv (IL); Yotam Platner, Tel-Aviv (IL); Or Davidi, Tel-Aviv (IL); Oren Kaikov, Tel-Aviv (IL)

(21) Appl. No.: 18/305,676

(22) Filed: Apr. 24, 2023

(51) Int. Cl. G06N 5/04

(52) U.S. Cl. CPC G06N 5/04

(57) ABSTRACT

Systems and techniques of the present disclosure enable a compiler to optimize such tradeoffs, and further enable optimization for a specific user cost function (e.g., optimization of a complex multi-dimensional and non-linear problem). Moreover, the techniques described herein can optimize in polynomial time. Accordingly, inference tasks may be optimized (e.g., based on specific applications) in terms of power consumption, idle time, the efficiency of computation, system resources, etc. For instance, by leveraging the systems and techniques described in the present disclosure, hardware designers can balance the tradeoff between runtime, power consumption, and resource usage, which are critical factors in the efficient processing of specialized tasks.

### BACKGROUND

The following relates generally to artificial intelligence (AI) inference optimization, and more specifically to complex non-linear multi-dimensional cost functions for artificial intelligence inference engines.

AI has been transforming various industries by enabling automation, data analysis, and decision-making. In some aspects, AI models are built using machine learning techniques, which may include the processing of large amounts of data through neural networks. As an example, AI inference includes processes such as making predictions or decisions based on previously learned patterns. Such may involve feeding new data into a machine learning model, which then uses algorithms to analyze and interpret the data (e.g., leading to a prediction or decision). The machine learning model may be trained on a large dataset of similar data, allowing the machine learning model to recognize and classify patterns and make predictions based on the new data.

In some aspects, traditional hardware (e.g., traditional central processing unit (CPU) hardware) may not be optimized for the high-performance requirements of AI inference, and thus, specialized hardware has been developed to improve performance and efficiency. In some cases, graphics processing units (GPUs), field-programmable gate arrays (FPGAs), and application-specific integrated circuits (ASICs), may be specialized (e.g., reconfigured, optimized, etc.) to accelerate the processing of AI inference tasks. For instance, GPUs may be adapted to perform AI inference due to their ability to perform parallel processing, FPGAs may be programmed to perform specific AI inference tasks, ASICs may be custom-built circuits designed to perform specific AI inference tasks, etc.

However, inference may be costly in terms of runtime (e.g., computation latency), power (e.g., power consumption and/or battery requirements), system resources (e.g., memory bandwidth, hardware area), etc. Various processing techniques and hardware design considerations may attempt to balance these tradeoffs using specialized processing units, memory hierarchies, and architectural optimizations. As the use of AI continues to grow, there is an increasing demand for more efficient and more powerful AI solutions.

### SUMMARY

A method, apparatus, non-transitory computer readable medium, and system for complex non-linear multi-dimensional cost functions for artificial intelligence inference engines are described. One or more aspects of the method, apparatus, non-transitory computer readable medium, and system include obtaining an algorithm for a computational graph; computing an initial linearized metric for a performance parameter for performing the algorithm using a hardware device; computing an updated linearized metric based on the initial linearized metric and a non-linear constraint on the performance parameter; and programming the hardware device to implement the computational graph based on the updated linearized metric.

### BRIEF DESCRIPTION OF THE DRAWINGS

FIGS. 1 and 2 show example computing systems according to aspects of the present disclosure.

FIG. 3 shows a flowchart of example artificial intelligence (AI) inference optimization operations according to aspects of the present disclosure.

FIG. 4 shows an example of a method for AI inference optimization according to aspects of the present disclosure.

FIGS. 5A, 5B, and 6 show examples of neural network graphs according to aspects of the present disclosure.

FIG. 7 shows an example of a dynamic programming diagram according to aspects of the present disclosure.

FIG. 8 shows an example of a data representation diagram according to aspects of the present disclosure.

### DETAILED DESCRIPTION

Artificial intelligence (AI) has become an integral part of many modern applications, ranging from image and speech recognition to natural language processing and autonomous systems. AI techniques may often include processing tasks such as training and inference. For example, training processes may include teaching an AI model to perform a specific task by exposing the model to a large amount of data. During the training process, an AI model learns to identify patterns and relationships in the data, and the model uses such training to make predictions or decisions using new (e.g., unseen) data. AI inference involves using a trained AI model to process new input data to make decisions or predictions based on the input data.

To enable efficient and accurate AI inference, specialized processing techniques and specialized hardware have been developed. For example, architectural optimizations, such as pipelining, parallelism, and vectorization, may aim to reduce runtime and power consumption by improving the efficiency of computation, reducing idle time, etc. Moreover, memory hierarchies may be implemented to provide different levels of memory bandwidth and capacity (e.g., and optimizing the size and hierarchy of memory resources may balance a tradeoff between memory usage and power consumption).

Inference (e.g., convolutional neural network (CNN) inference) may be costly in terms of runtime, power, and system resources. In some examples, edge AI hardware accelerators may include a small cache to lower those costs, but such implementations may be area-expensive. Further, different compile time decisions may affect the trade-off between runtime, power, and system resource costs. As an example, in contrast to other application compilation, a CNN graph is deterministic in millions of operations. This domain specific approach enables deep optimization a-priory to the inference execution. The desired runtime, power, and bandwidth may differ greatly and in a non-linear manner from the user perspective.

The techniques described herein enable the compiler to optimize such tradeoffs, thus enabling optimization for a specific user cost function (e.g., optimization of a complex multi-dimensional and non-linear problem). Moreover, the techniques described herein optimize in polynomial time (e.g., whereas other methods may suggest approximations or exponential runtime with respect to the amount of CNN algorithm layers). As described in more detail herein, one or more aspects of the present disclosure may optimize edge AI hardware accelerator performance. Moreover, optimization algorithms described herein may be generic for any A-cyclic computation-graph (e.g., and not limited to CNNs), as well as generic for various computation units (e.g., including central processing units (CPUs), graphics processing units (GPUs), neural processing units (NPUs), etc.).

Accordingly, AI inference tasks may be optimized (e.g., based on specific applications) in terms of power consumption, idle time, the efficiency of computation, system resources, etc. For instance, by leveraging the systems and techniques described in the present disclosure, hardware designers can balance the tradeoff between runtime, power consumption, and resource usage, which are critical factors in the efficient processing of specialized AI tasks.

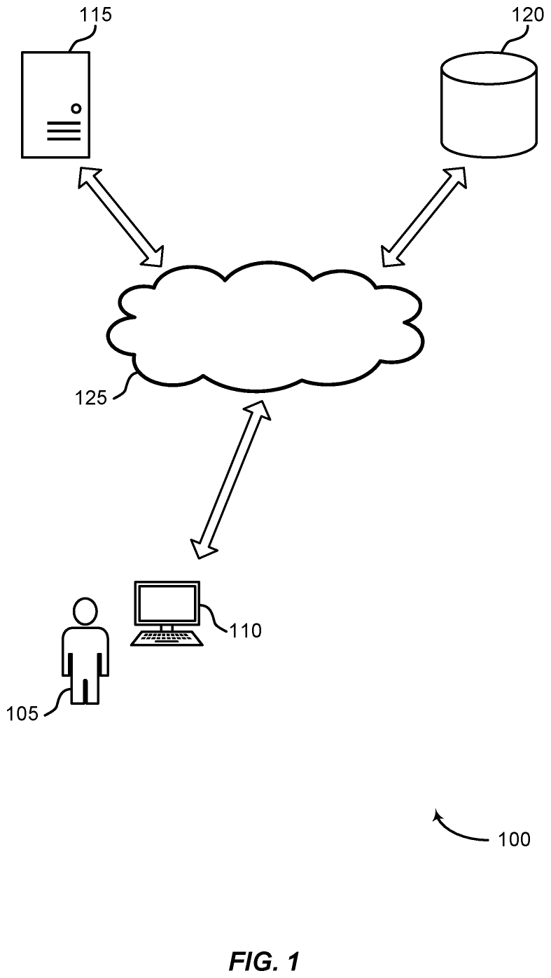

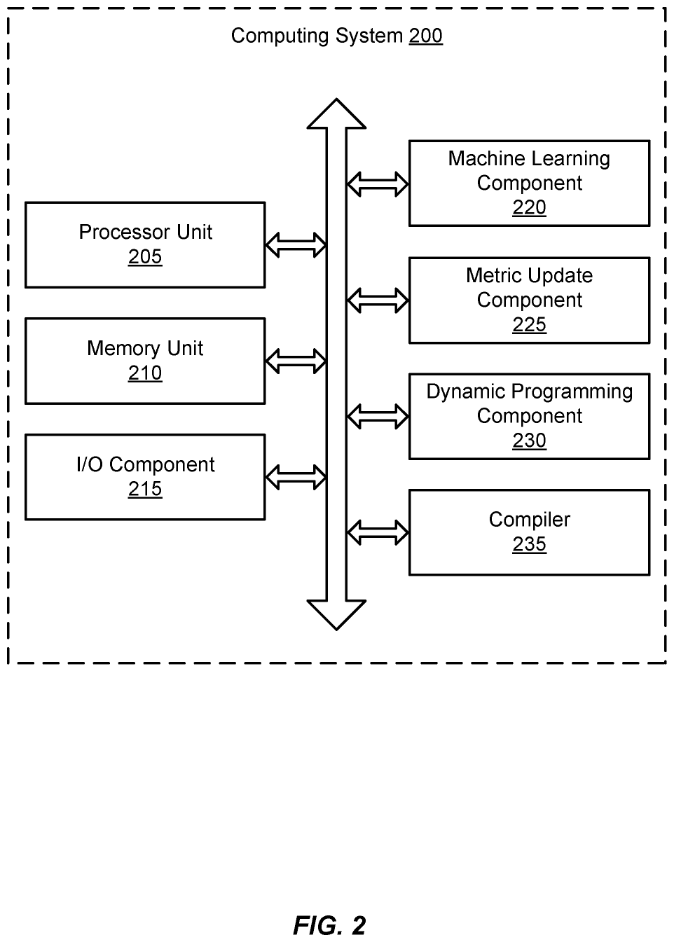

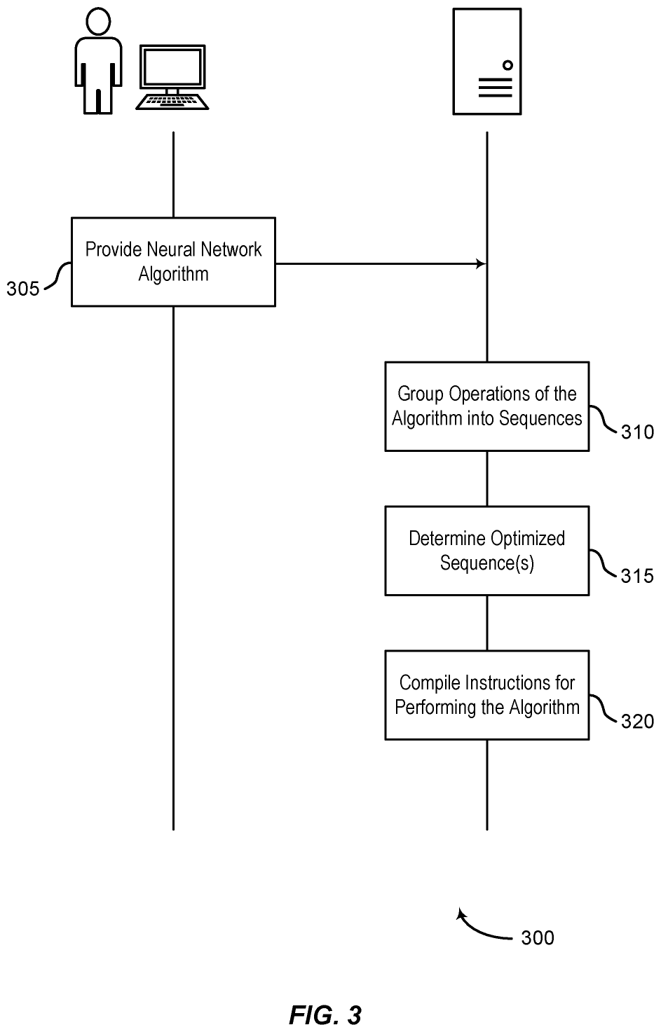

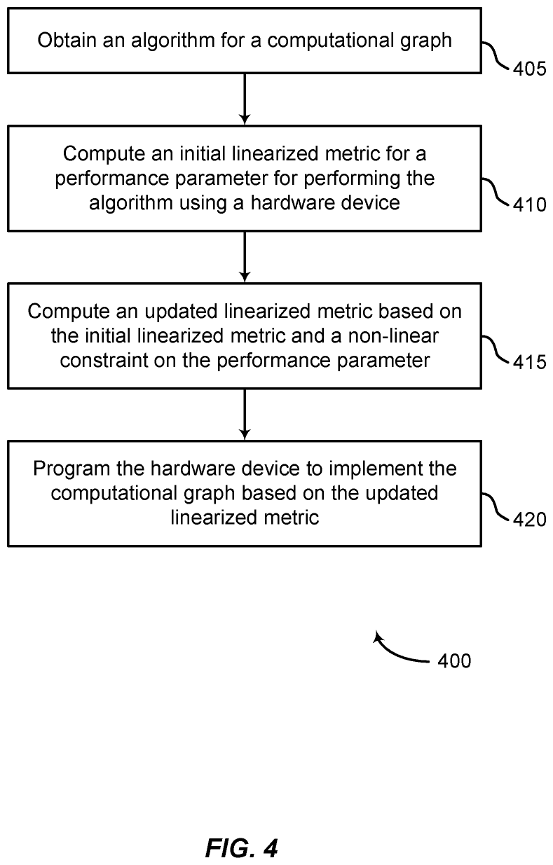

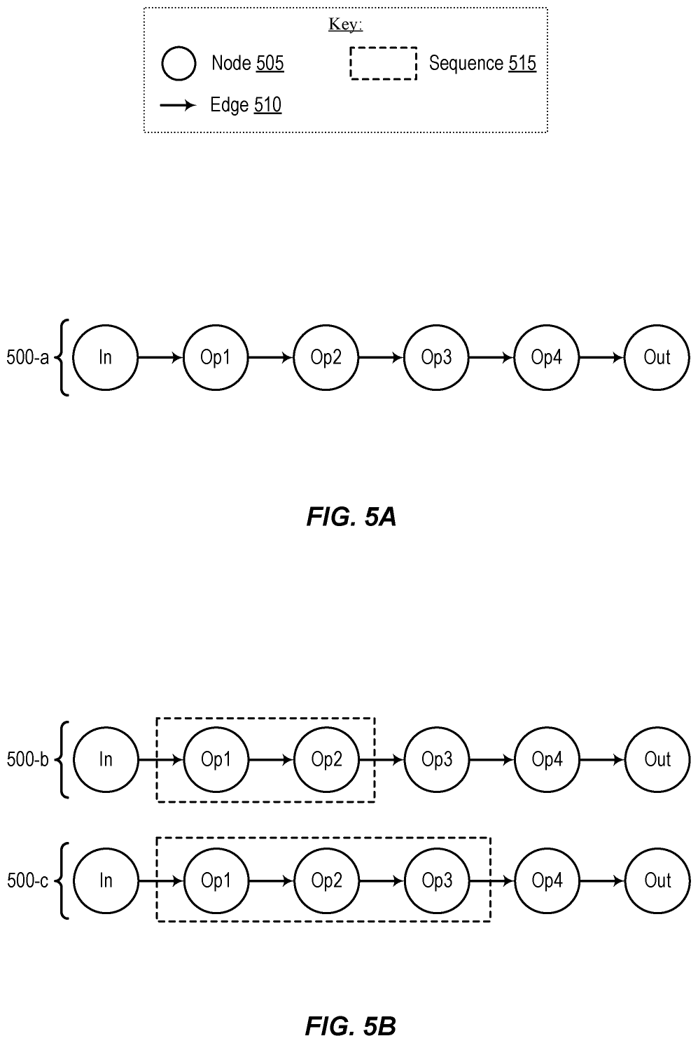

Embodiments of the present disclosure may be used in various contexts, such as in a computing system. For example, a computing system based on the present disclosure may implement optimization algorithms for any A-cyclic computation-graph, as described in more detail below. One or more aspects of the inventive concept, in the computing system context, are provided with reference to FIGS. 1 and 2. Moreover, details regarding example AI inference optimization are provided with reference to FIGS. 3 and 4. Example neural network graphs and dynamic programming diagrams are provided with reference to FIGS. 5A, 5B, 6, 7, and 8.

### System Architecture

FIG. 1 shows an example of a computing system 100 according to aspects of the present disclosure. Computing system 100 is an example of, or includes aspects of, the corresponding element described with reference to FIG. 2. In one aspect, the example computing system 100 of FIG. 1 includes user 105, device 110, server 115, database 120, and cloud 125. For instance, device 110 may be used by a user 105 (e.g., engineers, researchers, scientists, etc.) for various computing tasks such as, for example, creating and testing machine learning models, performing machine learning tasks, implementing neural networks, etc.

In some aspects, device 110 may include a computing device 110 such as a personal computer, desktop computer, laptop computer, mainframe computer, palmtop computer, personal assistant, mobile device 110, or any other suitable processing apparatus. In some examples, device 110 may be equipped with various hardware and software (e.g., processors, graphics cards, etc.) to handle computational demands of machine learning.

A server 115 may provide one or more functions to users 105 linked by way of one or more of the various networks. In some cases, the server 115 includes a single microprocessor board, which includes a microprocessor responsible for controlling all aspects of the server 115. In some cases, a server 115 uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server 115 is configured to send and receive hypertext markup language (HTML) formatted files (e.g., for displaying web pages). In various embodiments, a server 115 comprises a general purpose computing device, a personal computer, a laptop computer, a mainframe computer, a supercomputer, or any other suitable processing apparatus. In some aspects, server 115 may host machine learning models and algorithms, making them accessible to other computers on a network (e.g., such as device 110). For instance, in some cases, the server 115 may provide the computational power to enable machine learning applications (e.g., such as by handling/processing neural network algorithms, large amounts of data, etc.).

A database 120 is an organized collection of data. For example, a database 120 stores data in a specified format known as a schema. A database 120 may be structured as a single database 120, a distributed database 120, multiple distributed databases 120, or an emergency backup database 120. In some cases, a database 120 controller may manage data storage and processing in a database 120. In some cases, a user 105 interacts with database 120 controller. In other cases, database 120 controller may operate automatically without user 105 interaction. In some cases, database 120 may be used to store data sets used to train machine learning models. For instance, database 120 may provide a central location for storing and managing data, allowing for easier access and manipulation of the data during model development processes, during implementation of machine learning tasks, etc.

A cloud 125 is a computer network configured to provide on-demand availability of computer system resources, such as data storage and computing power. In some examples, the cloud 125 provides resources without active management by the user 105. The term cloud 125 is sometimes used to describe data centers available to many users 105 over the Internet. Some large cloud 125 networks have functions distributed over multiple locations from central servers 115. A server 115 is designated an edge server 115 if it has a direct or close connection to a user 105. In some cases, a cloud 125 is limited to a single organization. In other examples, the cloud 125 is available to many organizations. In one example, a cloud 125 includes a multi-layer communications network comprising multiple edge routers and core routers. In another example, a cloud 125 is based on a local collection of switches in a single physical location. In some aspects, cloud 125 may include, or may refer to, a network of remote servers 115 that are used to store and process data (e.g., rather than on a local server or on device 110). In machine learning, cloud 125 may be used to host the machine learning models and provide a scalable infrastructure for training and inference.

According to one or more aspects of the present disclosure, computing system 100 may enable users 105 to efficiently create and deploy complex models that can drive valuable insights and decision-making. In some aspects, systems and techniques may be described in the context of CNNs and hardware implementation of AI inference engines. However, the present disclosure is not limited thereto. For example, the described systems and techniques may be generalized to computations that can be performed as an a-cyclic graph (e.g., to optimize a complex multi-dimensional and non-linear problem). For instance, a compiler may optimize power, runtime, and bandwidth for various applications, enabling efficient implementation of machine learning products with minimal resources usage.

FIG. 2 shows an example of a computing system 200 according to aspects of the present disclosure. In one aspect, computing system 200 includes processor unit 205, memory unit 210, I/O component 215, machine learning component 220, metric update component 225, dynamic programming component 230, and compiler 235. Computing system 200 is an example of, or includes aspects of, the corresponding element described with reference to FIG. 1. For example, in some implementations, computing system 200 may be implemented as device 110 or as server 115. In some implementations, computing system 200 may be implemented via a combination of device 110, server 115, database 120, and cloud 125 (e.g., where components of computing system 200, and operations performed by computing system 200, may be distributed across the device 110, server 115, database 120, and cloud 125 according to various configurations). As described in more detail herein, computing system 200 may be implemented to optimize a complex non-linear multi-dimensional cost function for AI inference engines.

A processor unit 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor unit 205 is configured to operate a memory array using a memory controller. In other cases, a memory controller is integrated into the processor unit 205. In some cases, the processor unit 205 is configured to execute computer-readable instructions stored in a memory to perform various functions. In some embodiments, a processor unit 205 includes special purpose components for modem processing, baseband processing, digital signal processing, or transmission processing.

Examples of a memory unit 210 (e.g., a memory device) include random access memory (RAM), read-only memory (ROM), or a hard disk. Examples of memory units 210 include solid state memory and a hard disk drive. In some examples, memory unit 210 is used to store computer-readable, computer-executable software including instructions that, when executed, cause a processor unit 205 to perform various functions described herein. In some cases, the memory unit 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory unit 210 store information in the form of a logical state.

An I/O component 215 (e.g., an I/O controller) may manage input and output signals for a device. I/O component 215 may also manage peripherals not integrated into a device. In some cases, an I/O component 215 may represent a physical connection or port to an external peripheral. In some cases, an I/O component 215 may utilize an operating system such as iOS®, ANDROID®, MS-DOS®, MS-WINDOWS®, OS/2®, UNIX®, LINUX®, or another known operating system. In other cases, an I/O component 215 may represent or interact with a modem, a keyboard, a mouse, a touchscreen, or a similar device. In some cases, an I/O component 215 may be implemented as part of a processor unit 205. In some cases, a user may interact with a device via I/O component 215 or via hardware components controlled by an I/O component 215.

According to some aspects, machine learning component 220 obtains an algorithm for a computational graph. In some examples, machine learning component 220 identifies a set of layers of the computational graph. In some examples, machine learning component 220 groups the set of layers into a set of sequences. In some examples, machine learning component 220 identifies a tiling of the set of layers, where the hardware device is programmed based on the tiling.

According to some aspects, metric update component 225 computes an initial linearized metric for a performance parameter for performing the algorithm using a hardware device. In some examples, metric update component 225 computes an updated linearized metric based on the initial linearized metric and a non-linear constraint on the performance parameter. In some examples, metric update component 225 determines an initial weight for the performance parameter. In some examples, metric update component 225 computes a weighted sum of a set of linearized metrics including the initial linearized metric based on a set of initial weights including the initial weight, where the initial score is based on the weighted sum. In some examples, metric update component 225 determines an updated weight for the performance parameter based on the initial score.

According to some aspects, dynamic programming component 230 programs the hardware device to implement the computational graph based on the updated linearized metric. In some examples, dynamic programming component 230 performs a dynamic programming process to identify a subset of sequences from the set of sequences, where the initial linearized metric is based on the subset of sequences, and where the dynamic programming process is based on a linearity constraint on the performance parameter. In some examples, dynamic programming component 230 performs an additional dynamic programming process to identify an updated subset of sequences from the set of sequences, where the updated linearized metric is based on the updated subset of sequences, where the hardware device is programmed based on the updated subset of sequences. In some examples, dynamic programming component 230 computes an initial score for the subset of sequences based on the initial linearized metric and the initial weight. In some examples, dynamic programming component 230 computes an updated score for the subset of sequences based on the updated weight and the updated linearized metric, where the subset of sequences is selected based on the updated score. In some examples, dynamic programming component 230 computes scores for a set of subsets of sequences, respectively, where the subset of sequences is selected from the set of subsets of sequences based on the scores. In some examples, dynamic programming component 230 computes a non-linear term based on the initial weight and the non-linear constraint, where the initial score is based on the non-linear term. In some examples, dynamic programming component 230 modifies a design for the hardware device based on the updated linearized metric, where the hardware device is programmed based on the modified design. In some examples, dynamic programming component 230 modifies an algorithm for the computational graph based on the updated linearized metric, where the hardware device is programmed based on the modified algorithm.

According to some aspects, compiler 235 compiles instructions for performing the algorithm based on the updated linearized metric, where the hardware device is programmed based on the compiled instructions.

### AI Inference Optimization

FIG. 3 shows an example of a method 300 an example flowchart of operations between a user (computing device) and a server for optimizing and compiling an algorithm for a computational graph according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 305, the system provides an algorithm (e.g., a neural network algorithm) for a computational graph to a server. In some cases, the operations of this step refer to, or may be performed by, a user as described with reference to FIG. 1. In some cases, the operations of this step refer to, or may be performed by, a device as described with reference to FIG. 1.

At operation 310, the system breaks layers of the computational graph into sequences. In some cases, the operations of this step refer to, or may be performed by, a computing system as described with reference to FIGS. 1 and 2. In some cases, the operations of this step refer to, or may be performed by, a machine learning component as described with reference to FIG. 2.

At operation 315, the system determines an optimized subset of sequences for implementing the computational graph. In some cases, the operations of this step refer to, or may be performed by, a computing system as described with reference to FIGS. 1 and 2. In some cases, the operations of this step refer to, or may be performed by, a dynamic programming component as described with reference to FIG. 2.

At operation 320, the system performs the algorithm based on the optimized subset of sequences. In some cases, the operations of this step refer to, or may be performed by, a computing system as described with reference to FIGS. 1 and 2. In some cases, the operations of this step refer to, or may be performed by, a compiler as described with reference to FIG. 2.

FIG. 4 shows an example of a method 400 for artificial intelligence inference optimization according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, the system obtains an algorithm for a computational graph. In some cases, the operations of this step refer to, or may be performed by, a machine learning component as described with reference to FIG. 2.

At operation 410, the system computes an initial linearized metric for a performance parameter for performing the algorithm using a hardware device. In some cases, the operations of this step refer to, or may be performed by, a metric update component as described with reference to FIG. 2.

At operation 415, the system computes an updated linearized metric based on the initial linearized metric and a non-linear constraint on the performance parameter. In some cases, the operations of this step refer to, or may be performed by, a metric update component as described with reference to FIG. 2.

At operation 420, the system programs the hardware device to implement the computational graph based on the updated linearized metric. In some cases, the operations of this step refer to, or may be performed by, a dynamic programming component as described with reference to FIG. 2.

Accordingly, methods, apparatuses, non-transitory computer readable medium, and systems for complex non-linear multi-dimensional cost functions for AI inference engines are described. One or more aspects of the method, apparatus, non-transitory computer readable medium, and system include obtaining an algorithm for a computational graph; computing an initial linearized metric for a performance parameter for performing the algorithm using a hardware device; computing an updated linearized metric based on the initial linearized metric and a non-linear constraint on the performance parameter; and programming the hardware device to implement the computational graph based on the updated linearized metric.

Some examples of the method, apparatus, non-transitory computer readable medium, and system further include identifying a plurality of layers of the computational graph. Some examples further include grouping the plurality of layers into a plurality of sequences. Some examples further include performing a dynamic programming process to identify a subset of sequences from the plurality of sequences, wherein the initial linearized metric is based on the subset of sequences, and wherein the dynamic programming process is based on a linearity constraint on the performance parameter.

Some examples of the method, apparatus, non-transitory computer readable medium, and system further include identifying a tiling of the plurality of layers, wherein the hardware device is programmed based on the tiling.

Some examples of the method, apparatus, non-transitory computer readable medium, and system further include performing an additional dynamic programming process to identify an updated subset of sequences from the plurality of sequences, wherein the updated linearized metric is based on the updated subset of sequences, wherein the hardware device is programmed based on the updated subset of sequences.

Some examples of the method, apparatus, non-transitory computer readable medium, and system further include determining an initial weight for the performance parameter. Some examples further include computing an initial score for the subset of sequences based on the initial linearized metric and the initial weight.

Some examples of the method, apparatus, non-transitory computer readable medium, and system further include computing a weighted sum of a plurality of linearized metrics including the initial linearized metric based on a plurality of initial weights including the initial weight, wherein the initial score is based on the weighted sum.

Some examples of the method, apparatus, non-transitory computer readable medium, and system further include determining an updated weight for the performance parameter based on the initial score. Some examples further include computing an updated score for the subset of sequences based on the updated weight and the updated linearized metric, wherein the subset of sequences is selected based on the updated score.

Some examples of the method, apparatus, non-transitory computer readable medium, and system further include computing scores for a plurality of subsets of sequences, respectively, wherein the subset of sequences is selected from the plurality of subsets of sequences based on the scores.

Some examples of the method, apparatus, non-transitory computer readable medium, and system further include computing a non-linear term based on the initial weight and the non-linear constraint, wherein the initial score is based on the non-linear term.

Some examples of the method, apparatus, non-transitory computer readable medium, and system further include compiling instructions for performing the algorithm based on the updated linearized metric, wherein the hardware device is programmed based on the compiled instructions.

Some examples of the method, apparatus, non-transitory computer readable medium, and system further include modifying a design for the hardware device based on the updated linearized metric, wherein the hardware device is programmed based on the modified design.

Some examples of the method, apparatus, non-transitory computer readable medium, and system further include modifying an algorithm for the computational graph based on the updated linearized metric, wherein the hardware device is programmed based on the modified algorithm.

### Neural Network Graphs

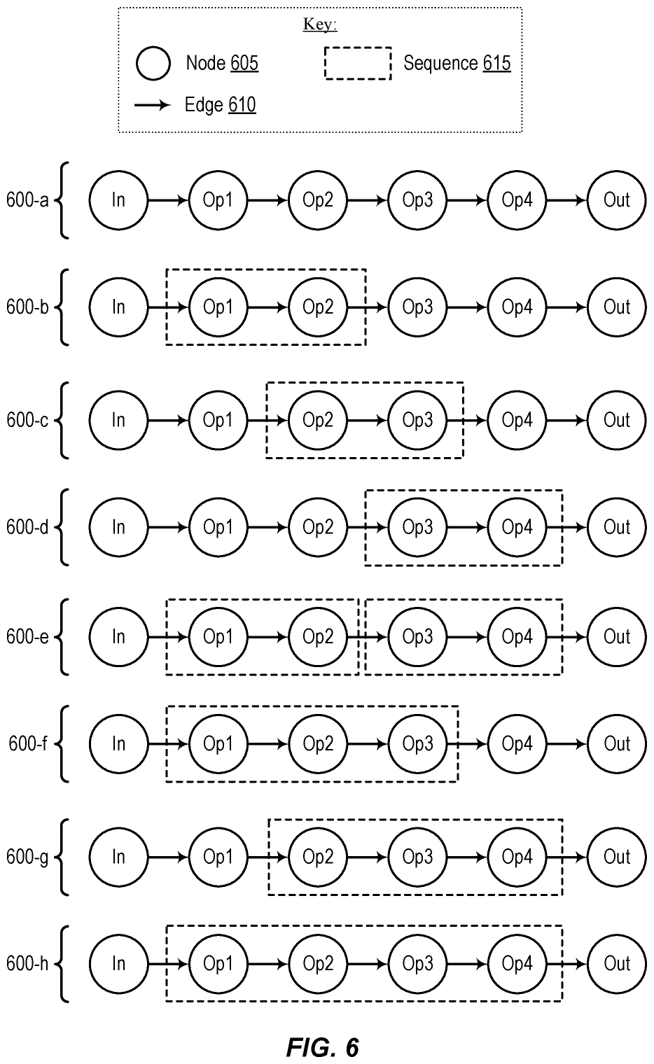

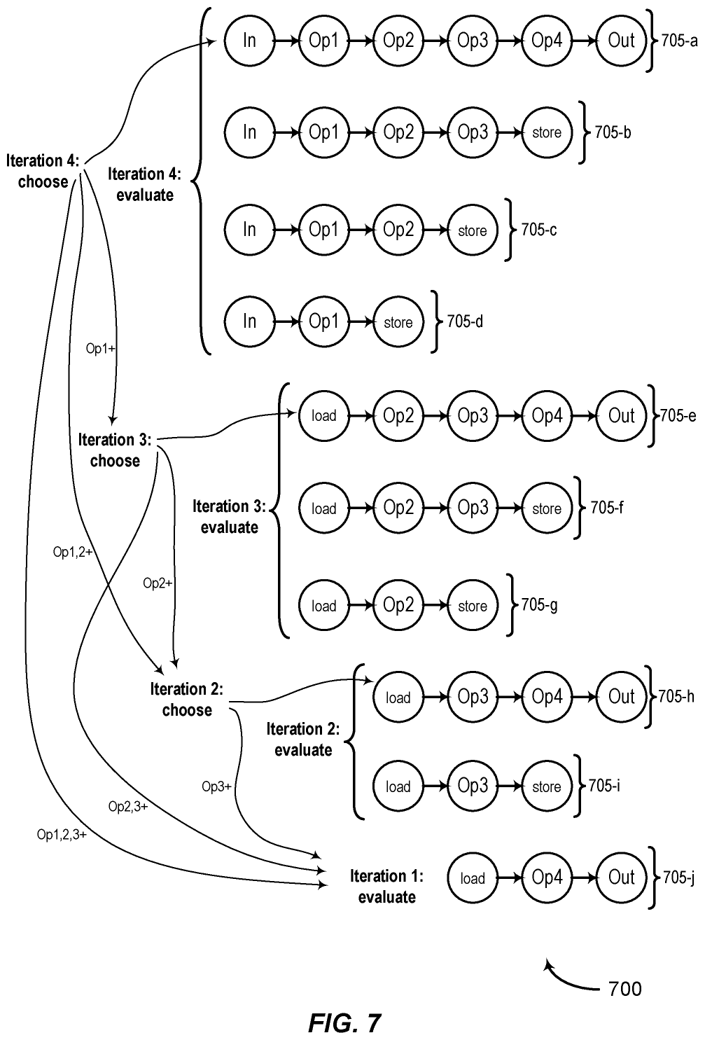

FIG. 5A shows an example of neural network graph 500-a according to aspects of the present disclosure. FIG. 5B shows example neural network graph 500-b and example neural network graph 500-c according to aspects of the present disclosure. Neural network graphs 500 may be examples of, or may include aspects of, one or more of the corresponding elements described with reference to FIGS. 6 and 7. In one aspect, neural network graphs 500 include nodes 505, edges 510, and sequences 515. Nodes 505 may be examples of, or may include aspects of, one or more of the corresponding elements described with reference to FIG. 6. Edges 510 may be examples of, or may include aspects of, one or more of the corresponding elements described with reference to FIG. 6. Sequences 515 may be examples of, or may include aspects of, one or more of the corresponding elements described with reference to FIG. 6.

An artificial neural network (ANN) is a hardware or a software component that includes a number of connected nodes 505 (i.e., artificial neurons), which may loosely correspond to the neurons in a human brain. Each connection (e.g., or edge 510) transmits a signal from one node 505 to another (like the physical synapses in a brain). When a node 505 receives a signal, it processes the signal and then transmits the processed signal to other connected nodes 505. In some cases, the signals between nodes 505 comprise real numbers, and the output of each node 505 is computed by a function of the sum of its inputs. In some examples, nodes 505 may determine their output using other mathematical algorithms (e.g., selecting the max from the inputs as the output) or any other suitable algorithm for activating the node 505. Each node 505 and edge 510 is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge 510 increases or decreases the strength of the signal transmitted between nodes 505. In some cases, nodes 505 have a threshold below which a signal is not transmitted at all. In some examples, the nodes 505 are aggregated into layers. Different layers perform different transformations on their inputs. The initial layer (e.g., which may be, or may include, input node 505 ‘In’) is known as the input layer and the last layer is known as the output layer (e.g., which may be, or may include, output node 505 ‘Out’). In some cases, signals traverse certain layers multiple times.

A CNN is a class of neural network that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

FIGS. 5A, 5B, and 6 show various examples of neural network graphs representing a linear network including only four operations (e.g., first operation ‘Op1’, second operation ‘Op2’, third operation ‘Op3’, fourth operation ‘Op4’).

According to the examples in FIGS. 5A, 5B, 6, and 7, a neural network computational graph (e.g., neural network graph 500-a, neural network graph 500-b, etc.) is a graphical representation of operations and data flow in a neural network (e.g., such as in an ANN, CNN, etc.).

For example, in FIGS. 5A and 5B, neural network graph 500-a and neural network graph 500-b include a series of interconnected nodes 505. Each node 505 may represent a mathematical operation (e.g., some first operation ‘Op1’, second operation ‘Op2’, third operation ‘Op3’, fourth operation ‘Op4’, etc.) that transforms the input data in some way. In some cases, nodes 505 may be grouped into layers, with each layer performing a specific function (e.g., such as convolution or pooling).

In FIG. 5A, neural network graph 500-a represents the relations between a collection of entities. Entities may include, or be referred to as, nodes 505. Relationships may include, or be referred to as, edges 510. In neural network graphs 500, each edge 510 may have a direction (e.g., which is following the direction of the data flow). In some neural networks, operations can be grouped into sequences 515 for processing. For instance, in FIG. 5B, nodes 505 may be grouped into sequences 515, which may represent corresponding operations that are grouped for processing.

When performing an inference for a given network, each operation has input and output data. This data can be stored in an external memory (e.g., dynamic random access memory (DRAM)) or inside the inference engine in an internal memory (e.g., static random access memory (SRAM)). For instance, when choosing to store the data inside the engine a sequence of operations is established (e.g., which are executed without exiting to the external memory). Within a sequence 515, the processing of operations use SRAM, a type of memory that may be faster and more power-efficient than DRAM. In some cases, using SRAM within a sequence 515 allows for faster processing of the data within that sequence 515. Operations outside of the sequence 515, however, may use DRAM. DRAM is a type of memory that may be slower and less power-efficient than SRAM, but may have a higher capacity. In some cases, using DRAM outside of the sequence 515 allows for more efficient memory utilization and processing of larger amounts of data.

In one example, neural network graph 500-a does not include sequences 515 with multiple nodes 505. That is, each operation ‘Op1’, ‘Op2’, ‘Op3’, and ‘Op4’ is performed separately. In this example, data from each operation may be input and output to DRAM separately.

By contrast, neural network graph 500-b includes a sequence 515 including nodes 505 representing multiple operations (e.g., ‘Op1’ and ‘Op2’). In this example, the data of operations ‘Op1’ and ‘Op2’ may be grouped for processing and input/output to SRAM, whereas data from operations ‘Op3’ and ‘Op4’ may be input/output to DRAM.

Similarly, neural network graph 500-c includes a sequence 515 including nodes 505 representing operations ‘Op1’, ‘Op2’, and ‘Op3’ where data of operations ‘Op1’, ‘Op2’, and ‘Op3’ may be grouped for processing and input/output to SRAM; and data of operation ‘Op4’ may be input/output to DRAM.

Connecting operations in a sequence 515 may save memory bandwidth (e.g., and by that may also save power). A sequence 515 may also save runtime, as the time it takes to write and read that data (e.g., to DRAM) is being saved. In some cases, due to receptive field, a long sequence 515 may also increase computation and memory bandwidth. Accordingly, optimizing configuration of sequences 515 may optimize performance. In some cases, a neural network graph can be “solved” by selecting a combination of sequences 515 such that each operation belongs to exactly one of the sequences 515.

FIG. 6 shows example neural network graphs 600-a through 600-h according to aspects of the present disclosure. Neural network graphs 600a-h may be examples of, or may include aspects of, one or more of the corresponding elements described with reference to FIGS. 5 and 7. In one aspect, neural network graphs 600a-h may include nodes 605, edges 610, and sequences 615. Nodes 605 may be examples of, or may include aspects of, one or more of the corresponding elements described with reference to FIG. 5. Edges 610 may be examples of, or may include aspects of, one or more of the corresponding elements described with reference to FIG. 5. Sequences 615 may be examples of, or may include aspects of, one or more of the corresponding elements described with reference to FIG. 5.

In some examples, multiple nodes 605 can be combined to form a sequence 615. In some examples, a single node 605, representing a single layer or operation, can also be considered as sequence 615, and can be divided into tiles. In some examples, a processor can store data in an internal memory or register before processing. When performing processing for convolution operations, pieces of data can be used multiple times (to obtain multiple different outputs). Therefore, by selecting an efficient set of sequences, embodiments of the present disclosure can increase the efficiency of a processor by reducing the number of times that some pieces of data are read into memory.

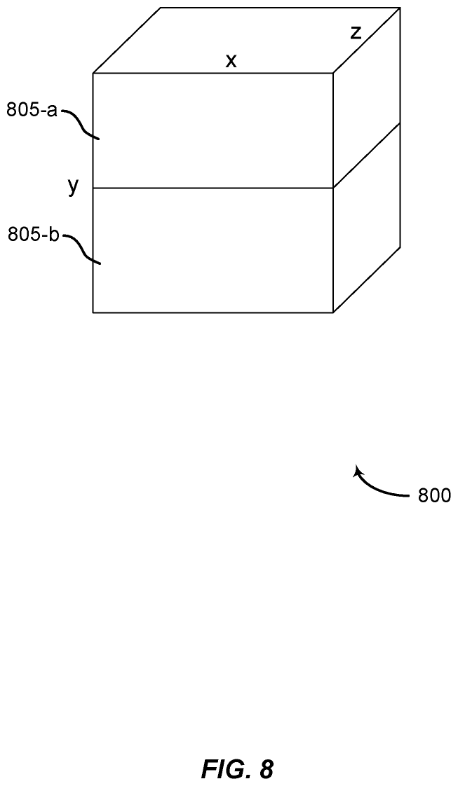

The systems and techniques described herein may simplify and optimize a CNN inference given a non-linear multi-dimensional cost function (metric). As described herein, to fit the data and parameters (tensors) of the calculations into the AI accelerator's internal memory, some (e.g., most) of the tensors may be tiled (e.g., as described in more detail herein, for example, with reference to FIG. 8). Each tile may add more compute and bandwidth overheads (e.g., both in power and runtime). To reduce runtime and bandwidth (as well as bandwidth power) sequencing may also be used.

Choosing optimal sequence boundaries for the graph is difficult, since a change in each sequence boundary effects its neighbors (e.g., and thus the entire graph, resulting in exponential complexity). However, if the metric (e.g., the cost of (bandwidth,power,runtime)) is linear, a memoization (e.g., dynamic programing) approach can be applied (e.g., starting in the graph end, and going backwards). This approach may solve the problem in complexity of O(N²). To apply the memoization technique to any non-linear function, the metric may be linearized at a predicted point. Otherwise, the predicted point may be re-evaluated, and the process repeats itself.

One approach to finding an optimal sequence may include trying (e.g., testing) all combinations of sequences. However, this approach may involve testing a number of combination on the order of O(N²). Furthermore, the testing may not converge in long and complicated networks. In a linear network there can be

$$\\ N \frac{( N + 1 )}{2}$$

different type of sequences 615 and 2^{N-1} different combinations of sequences that solve the graph.

Accordingly, in the example of FIG. 6 (i.e., with four operations) there can be

$$\\ 4 \frac{( 4 + 1 )}{2} = 10$$

different sequences 615: [1], [2], [3], [4], [1-2], [2-3], [3-4], [1-3], [2-4], [1-4] and 23=8 different combinations of sequences 615 which solve the graph: [1, 2, 3, 4], [1-2, 3, 4], [1, 2-3, 4], [1, 2, 3-4], [1-2, 3-4], [1-3, 4], [1, 2-4], [1-4].

Neural networks (e.g., and computational graphs) may be built from hundreds of layers, and the approach of trying all options is far too complex. To apply the memoization over the CNN graph, an example algorithm starts with the graph end, and goes in reverse order, each time emulating a new subgraph from the current start node 605, until each possible intermediate node 605, and choses the best from those options. When the algorithm reaches the graph source nodes 605, the algorithm assesses the chain of sequences 615 that optimize the linearized metric (e.g., as described in more detail herein, for example, with reference to FIG. 7).

FIG. 7 shows an example of a dynamic programming diagram 700 according to aspects of the present disclosure. In one aspect, the example dynamic programming diagram 700 of FIG. 7 includes neural network graphs 705-a through 705-j. Neural network graphs 705 may be examples of, or may include aspects of, one or more of the corresponding elements described with reference to FIGS. 5 and 6.

Dynamic programming diagram 700 may illustrate one or more aspects of memorization techniques (e.g., over a CNN graph, such as over neural network graphs 705-a through 705-j). For instance, a first iteration (e.g., ‘Iteration 1’) may begin with a graph end (e.g., neural network graph 705-j), and the dynamic programming diagram 700 may proceed in reversed order (e.g., each time emulating a new subgraph from the current start node through each possible intermediate node, and evaluating the best from those options). When the algorithms reach the graph source nodes, it assesses the chain of sequences that optimize the linearized metric.

In some aspects, FIG. 7 shows recursive selection best sequence combinations given linearity. The evaluation of each sequence (e.g., the evaluation of each neural network graph 705) may be additive for a linearized metric, and may be evaluated separately using a hardware emulator. Having a linearized the metric may solve the sequence selection as well as enable a compiler to optimize each of the sequences independently to minimize the same metric. The linearized score may then be compared with the original metric, the linearization may be updated, the process may be repeated until the linearized metric and the original metric converge (e.g., and when the process is done, the original metric may be optimized).

A multi-dimensional non-liner cost function may be described according to Equation (1).

$$\\ \begin{matrix}score = {\sum }_{i ∈ \{ bw , rt , ej , area , acc \}} \{ \begin{matrix}{w}_{i} \cdot \frac{{meas}_{i}}{{lim}_{i}} , {meas}_{i} < \begin{matrix}lim \\ i\end{matrix} \\ {w}_{i} + ( {e}^{{}_{} 10 \cdot ( \frac{{meas}_{{i}_{}}}{{lim}_{i}} - 1 )} - 1 ) , {meas}_{i} \geq \begin{matrix}lim \\ i\end{matrix}\end{matrix} & ( 1 )\end{matrix}$$

In some aspects, the limit may represent, for example, project requirements, design constraints, tradeoff optimizations, etc. For instance, the limit may represent a power limit, a runtime (or latency) limit, a bandwidth (memory) limit, etc. As one example, an example limitation/constraint for an implementation may include power being below 20 mA. In such an example, the cost function may be linear up to 20 mA, and from 20 mA the cost function may become exponential (e.g., in order to reflect the cost).

As discussed herein, in order to solve a multi-dimensional cost function with dynamic programing by memorization, the function may be linearized (e.g., according to the techniques described herein).

$$\\ \begin{matrix}score = {\sum }_{i ∈ \{ bw , rt , ej , area , acc \}} {\hat{w}}_{i} \cdot \frac{{meas}_{i}}{{lim}_{i}} & ( 2 )\end{matrix}$$

where the value of ŵᵢ may be calculated using an assumed working point.

Once the full graph cost is calculated, either an optimal working point is reached where all dimensions are below limitations or the cost function is above limitation in one or more dimensions. In the later scenario, in order to find an optimal solution, the linear cost function weight ŵᵢ may be updated. Once the weights are updated, the flow may be started again and may repeat until an optimal solution is found.

For example, the cost functions described herein (e.g., such as with reference to Equation (1)) may be piecewise functions with a linear component and a non-linear component. Generally, such a piecewise cost function may be defined by multiple (e.g., two) sub-functions, with each sub-function being applicable over a specific domain or interval. Different sub-functions may thus be defined using conditional statements or inequalities, and the overall cost function may be constructed by combining these sub-functions. The resulting piecewise cost function may be continuous over its domain and may take on different forms or values depending on the input variable's value within the specified intervals.

For instance, a cost function may include a linear component (e.g., a linear function, such as

$$\\ {w}_{i} \cdot \frac{{meas}_{i}}{{lim}_{i}} )$$

for measurement values (e.g., measᵢ) under a limit

$$\\ ( e . g . , \begin{matrix}lim \\ i\end{matrix} ) ,$$

and a non-linear component (e.g., a non-linear function, such as

$$\\ {w}_{i} + ( {e}^{{}_{} 10 \cdot ( \frac{{meas}_{{i}_{}}}{{lim}_{i}} - 1 )} - 1 ) {)}^{}$$

for measurement values equal to or exceeding the limit. i may represent different requirements for different limits (e.g., such as bandwidth ‘bw’, runtime ‘rt’, etc.). As described in more detail herein, dynamic programming techniques may assume linear function component of the cost function.

As an example, a network (e.g., a four operation linear network, such as a network represented by neural network graphs 500, 600, 700, etc.) may be optimized according to one or more aspects shown below with respect to Table 1.

TABLE 1
Sequence Value per Dimensions (A, B, and C)

| | Metric | | A | B | C |
|---|---|---|---|---|---|
| Weights | | | 0.5 | 1 | 1 |
| Limit | | | 6 | 6 | 6 |
| | Sequence | [1] | 1 | 2 | 3 |
| | | [1, 2] | 3 | 1 | 3 |
| | | [1, 2, 3] | 5 | 1 | 5 |
| | | [1, 2, 3, 4] | 8 | 3 | 6 |
| | | [2] | 2 | 3 | 4 |
| | | [2, 3] | 5 | 1 | 2 |
| | | [2, 3, 4] | 6 | 1 | 3 |
| | | [3] | 2 | 2 | 4 |
| | | [3, 4] | 3 | 5 | 3 |
| | | [4] | 4 | 2 | 1 |

Table 1 may represent a three-dimension cost values (A. B. and C), with a matching weight and limit per each dimension. For instance, the values in the table are given per optional sequence.

TABLE 2
List of Optional Graph Sequence Combinations

| | | | | Overall | iteration | iteration |
|---|---|---|---|---|---|---|
| Combinations | A | B | C | Score | 1 | 2 |
| [1], [2], [3], [4] | 9 | 9 | 12 | 1225.5 | 25.5 | 228 |
| [1, 2][3][4] | 9 | 5 | 8 | 517.5 | 17.5 | 220 |
| [1, 2, 3][4] | 9 | 3 | 6 | 313.5 | 13.5 | 216 |
| [1, 2, 3, 4] | 8 | 3 | 6 | 213 | 13 | 193 |
| [1], [2, 3], [4] | 10 | 5 | 6 | 416 | 16 | 241 |
| [1], [2, 3, 4] | 7 | 3 | 6 | 112.5 | 12.5 | 170 |
| [1, 2][3, 4] | 6 | 6 | 6 | 15 | 15 | 150 |
| [1][2][3, 4] | 6 | 10 | 10 | 823 | 23 | 158 |

In this example, Table 2 may represent the accumulated dimensional value for each sequence combination. The ‘overall score’ column may represent the real non-linear score of the sequence combination. However, for other networks (e.g., which may be combined from dozens of layers), listing all combinations may not be feasible in terms of run-time and memory. Hence, the dynamic programing techniques with memorization described herein may be implemented. For instance, in the example of FIG. 7, neural network graph 705-a may have a score of 13; neural network graph 705-b may have a score of 8.5+5=13.5; neural network graph 705-c may have a score of 5.5+9.5=15; neural network graph 705-d may have a score of 5.5+7=12.5; neural network graph 705-e may have a score of 7; neural network graph 705-f may have a score of 5.5+5=10.5; neural network graph 705-g may have a score of 8+9.5=17.5; neural network graph 705-h may have a score of 9.5; neural network graph 705-i may have a score of 7+5=12; and neural network graph 705-j may have a score of 5.

As shown in Table 2 (e.g., and FIG. 7), the best score of iteration 1 is 12.5, but the value of dimension A is above limitation. For this reason, the linear weights may be updated and the procedure may be repeated. Further, in iteration 2, the optimal solution may be reached (e.g., obtained, determined, etc.). Such an iterative process may continue until weight will converge (e.g., with minimal change in time).

FIG. 8 shows an example of a data representation diagram according to aspects of the present disclosure. In one aspect, data blob 800 includes tiles 805 (e.g., tile 805-a and tile 805-b). For instance, a data blob 800 may include or refer to a large set (or blob) of data. In some aspects, the data blob 800 may be represented as tiles (e.g., tiles 805-a and 805-b) and sequences (e.g., sequences 515, 615, etc.) for processing.

In some cases, a data blob 800 may include, or refer to, a collection of data (e.g., that may be stored as a single entity, such as in binary form, etc.). A data blob 800 may represent any type of information, such as data, information, images, videos, etc. In some aspects, a tile 805 may be defined as a smaller, rectangular (or cubical) subset of a larger two-dimensional (or three-dimensional) dataset. A tile 805 may be a fixed size or a variable size, depending on the application. By dividing a data blob 800 into smaller tiles 805, processing and rendering can be performed tile-by-tile (e.g., on only the visible portion of the dataset), which may improve performance and reduce memory usage. A sequence, on the other hand, may include, or refer to, a series of data items (e.g., operations) that are processed or analyzed in some order.

For example, FIG. 8 shows, a data blob 800 in (x, y, z) dimensions being tiled into two (e.g., into tile 805-a and tile 805-b) in the y dimension. When performing an inference on a specific operation, the size of the data may be defined by the size of the input data and the weights. When an inference engine has a smaller internal memory than some overall required memory size, the data may be split and the operation may be processed in tiles 805. The tile 805 may be performed in one or more dimensions of the data blob 800. In some aspects, tiling and sequencing can be defined together, when the sequence is being processed multiple times, each per different tile 805.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described systems and methods may be implemented or performed by devices that include a general-purpose processor, a DSP, an ASIC, a FPGA or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise RAM, ROM, electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an algorithm for a computational graph;
computing an initial linearized metric for a performance parameter for performing the algorithm using a hardware device;
computing an updated linearized metric based on the initial linearized metric and a non-linear constraint on the performance parameter; and
programming the hardware device to implement the computational graph based on the updated linearized metric.

2. The method of claim 1, further comprising:
identifying a plurality of layers of the computational graph;
grouping the plurality of layers into a plurality of sequences; and
performing a dynamic programming process to identify a subset of sequences from the plurality of sequences, wherein the initial linearized metric is based on the subset of sequences, and wherein the dynamic programming process is based on a linearity constraint on the performance parameter.

3. The method of claim 2, further comprising:
identifying a tiling of the plurality of layers, wherein the hardware device is programmed based on the tiling.

4. The method of claim 2, further comprising:
performing an additional dynamic programming process to identify an updated subset of sequences from the plurality of sequences, wherein the updated linearized metric is based on the updated subset of sequences, wherein the hardware device is programmed based on the updated subset of sequences.

5. The method of claim 4, further comprising:
determining an initial weight for the performance parameter; and
computing an initial score for the subset of sequences based on the initial linearized metric and the initial weight.

6. The method of claim 5, further comprising:
computing a weighted sum of a plurality of linearized metrics including the initial linearized metric based on a plurality of initial weights including the initial weight, wherein the initial score is based on the weighted sum.

7. The method of claim 5, further comprising:
determining an updated weight for the performance parameter based on the initial score; and
computing an updated score for the subset of sequences based on the updated weight and the updated linearized metric, wherein the subset of sequences is selected based on the updated score.

8. The method of claim 5, further comprising:
computing scores for a plurality of subsets of sequences, respectively, wherein the subset of sequences is selected from the plurality of subsets of sequences based on the scores.

9. The method of claim 5, further comprising:
computing a non-linear term based on the initial weight and the non-linear constraint, wherein the initial score is based on the non-linear term.

10. The method of claim 1, further comprising:
compiling instructions for performing the algorithm based on the updated linearized metric, wherein the hardware device is programmed based on the compiled instructions.

11. The method of claim 1, further comprising:
modifying a design for the hardware device based on the updated linearized metric, wherein the hardware device is programmed based on the modified design.

12. The method of claim 1, further comprising:
modifying an algorithm for the computational graph based on the updated linearized metric, wherein the hardware device is programmed based on the modified algorithm.

13. An apparatus comprising: a processor and a memory storing instructions and in electronic communication with the processor, the processor being configured to execute the instructions to:
obtain an algorithm for a computational graph;
compute an initial linearized metric for a performance parameter for performing the algorithm using a hardware device;
compute an updated linearized metric based on the initial linearized metric and a non-linear constraint on the performance parameter; and
program the hardware device to implement the computational graph based on the updated linearized metric.

14. The apparatus of claim 13, the processor being further configured to execute the instructions to:
identify a plurality of layers of the computational graph;
group the plurality of layers into a plurality of sequences; and
perform a dynamic programming process to identify a subset of sequences from the plurality of sequences, wherein the initial linearized metric is based on the subset of sequences, and wherein the dynamic programming process is based on a linearity constraint on the performance parameter.

15. The apparatus of claim 14, the processor being further configured to execute the instructions to:
identify a tiling of the plurality of layers, wherein the hardware device is programmed based on the tiling.

16. The apparatus of claim 14, the processor being further configured to execute the instructions to:
perform an additional dynamic programming process to identify an updated subset of sequences from the plurality of sequences, wherein the updated linearized metric is based on the updated subset of sequences, wherein the hardware device is programmed based on the updated subset of sequences.

17. The apparatus of claim 16, the processor being further configured to execute the instructions to:
determine an initial weight for the performance parameter; and
compute an initial score for the subset of sequences based on the initial linearized metric and the initial weight.

18. The apparatus of claim 17, the processor being further configured to execute the instructions to:
compute a weighted sum of a plurality of linearized metrics including the initial linearized metric based on a plurality of initial weights including the initial weight, wherein the initial score is based on the weighted sum.

19. The apparatus of claim 17, the processor being further configured to execute the instructions to:
determine an updated weight for the performance parameter based on the initial score; and
compute an updated score for the subset of sequences based on the updated weight and the updated linearized metric, wherein the subset of sequences is selected based on the updated score.

20. A non-transitory computer readable medium storing code, the code comprising instructions executable by a processor to:
obtain an algorithm for a computational graph;
compute an initial linearized metric for a performance parameter for performing the algorithm using a hardware device;
compute an updated linearized metric based on the initial linearized metric and a non-linear constraint on the performance parameter; and
program the hardware device to implement the computational graph based on the updated linearized metric.
